(19) United States
(12) Patent Application Publication
(10) Pub. No.: US 2004/0237078 A1
(43) Pub. Date: Nov. 25, 2004

(54) Method for updating software in different terminals

(76) Inventors: Josef Weiss, Ybbs/D (AT); Werner Dorrer, Wien (AT); Thomas Rock, Neustift-Innermanzing (AT); Andreas Mayerhofer, Wien (AT)

Correspondence Address: MORRISON & FOERSTER LLP, 1650 TYSONS BOULEVARD, SUITE 300, MCLEAN, VA, 22102, US

(21) Appl. No.: 10/491,526

(22) PCT Filed: Oct. 1, 2002
(86) PCT No.: PCT/DE02/03726

(30) Foreign Application Priority Data
Oct. 4, 2001 (DE) 101 48 875.0

(51) Int. Cl. G06F 9/44

(52) U.S. Cl. 717/168

(57) ABSTRACT

The invention relates to a method for updating software (sof) in different terminals (PEC, PAL), which are connected to a communications network (NET), said network allowing communication between the terminals. On request, the software state of software (sof) that is running on one of the terminals (PEC) is transmitted to the second terminal (PAL) via the communications network (NET) and software that is running on the second terminal (PAL), which corresponds to the software (sof) on the first terminal (PEC), is provided with the transmitted software state and continues to run on the second terminal (PAL) with the last current state of the first terminal (PEC). The software used is, for example, an agent software.

The invention relates to a method for updating software in different terminals which are connected to a communication network over which these terminals can communicate with each other.

As a rule modern applications have a variety of devices available to them such as personal computers, including desktop and/or laptop computers, mobile radio devices, handheld computers, etc. As a rule it is generally desirable here that all these devices have the latest data available to them. Thus for example software programs run on the devices given above for administration of data, which might relate to contact information or recording appointments for the user. A new entry in the appointments software of a hand-held computer for example now makes it necessary for an application to perform the relatively time-consuming procedure of updating this data in its latest version on all the additional devices on which they require to use this data. To do this the devices are as a rule to be linked to one the other via interfaces which normally differ from device to device. It is also advantageous for the same software to be running on the devices to be synchronized so that the update process can be designed to be simple and straightforward.

The disadvantage of this method is now, as is shown in practice, that on one hand the updating process by many users which is constantly necessary is felt to be laborious and these updates are therefore often only undertaken at irregular intervals, which frequently leads to data sets that differ from one another on the different devices.

On the other hand the state frequently occurs whereby the different devices are running under different operating systems with different software programs for processing a contact data record for example, so that the updating process here is made even more difficult and often information gets lost when data is being synchronized.

The problems outlined above do not however just occur in the for many users understandable situations of schedule and data maintenance but basically also when any change to the software itself which is made by a user. If for example specific changes are made to software settings on a desktop computer the settings must again be made separately by the user on the laptop computer so that this same configuration can be used on both computers.

In this context one term should be defined right at the outset. The term “software state” mentioned at the start of refers in this document on the one hand to actual states relating to the software, i.e. configuration changes etc. made to the software itself, on the other hand however it is taken to also mean for example “states” of data which can be processed, observed etc. with the corresponding software. In this sense for example appointment management software “X” with data sets “A” and “B” is in a different software state from the same appointment management software “X” with data sets “A”, “B” and “C”.

One object of the invention is to specify a solution for the above problem.

This object is achieved with a method mentioned at the start in that, in accordance with the invention

a) on request at least the software state of the software running on at least one of the terminals is transmitted via the communication network to the second terminal, and

b) software running on the second terminal and corresponding to the software on the first terminal is provided with the transmitted current software state and continues to run on the second terminal in the state which was the last current state on the first terminal.

With the aid of the method in accordance with the invention the latest software state is simply transferred to another desired device where software corresponding to the software running on the original device is provided with the actual state and then continues to run in the last state.

It is especially advantageous if the software on the second terminal corresponding to the software on the first terminal is transmitted from a memory location on the second terminal.

Whereas transmission of the variant part of the software, also referred to above as the “software state” is absolutely necessary for updating, transmission of the software per se, i.e. of the invariant executable part of the software, does not absolutely have to be undertaken. However the transmission “concurrent or retroactive” of the software to the second terminal—regardless of the location from which the software arrives at the second terminal—brings with it the advantages that the software only has to be a “installed” on one device, which naturally reduces the corresponding effort and ensures in an especially reliable way that the software is running on the desired terminal in each case in its very latest state and also in the same software version as it is running on the original device.

For example a software server which is connected to the communication network is used as storage location for the software. The software is stored centrally on this server or is created on this server on request and can be transmitted to the relevant terminal if required.

However there can also be provision for the storage location of the software to be a terminal on which the software is originally running. In this way independence from a central server can be achieved in an interchange between two terminals.

A technically simple-to-implement transmission is ensured if, with the method in accordance with the invention in step a) the software state is packed into a message which is transmitted to the second terminal.

The method can be implemented especially simply if an agent software is used as software. Such software has special characteristics which will be explained in more detail further on in this description. Because of these characteristics agents are particularly suitable for use in the method in accordance with the invention.

So that the software can be transferred quickly and reliably to the new terminal it is of advantage for the message to further contain the storage location of the software from which the software can then be transferred to the desired new terminal. In the case of software agents it is only necessary here for the message to contain at least the name of the main class and the storage location of the class definitions of the agent. After the message has been read, in the case of agent software the corresponding at least one or also a number of agents can then be created from this information on the second terminal, provided with the software state and then executed.

The class definitions are compiled JAVA code. Usually the code of each class is stored in its own class file. It is then present in a standardized binary form which can be read by any interpreter. If the program is started the interpreter translates the class file into computer-specific machine code and creates the program. Whenever it has to create a new class it fetches its definition from its memory location.

The main class is that class from which an interpreter finds the paths to all classes which it needs to create the agents step-by-step. It would also be possible to store the class definitions on the personal devices locally in order to speed up the loading process, but this would then involve taking account of version changes on all devices.

So that a user can update their software to be current software state when changing to the new terminal there is basic provision for the request to be issued using the first terminal on which the software is running.

Alternatively or additionally it is also possible for a request to be made from a second terminal via the communication network to the first terminal where it is transferred to the software and for this to then take the appropriate step for a transfer to the new terminal.

The request then includes transferring to the software a unique address of the terminal to which the software and the software state are to be transferred so that this can also be transferred reliably to the correct intended location. This address can either already be stored or entered additionally by the user.

If the internet is used as a communication network an IP address of the terminal is used as the address.

So that the latest data is always running for a transfer to a new terminal there is provision, after the request arrives, for the execution of the software to be stopped at the first terminal and for this or the software state to be transferred to the second terminal.

Certain applications such as for a telephone connection which is implemented with the software make it necessary for the connection to be maintained during the transfer. For this reason it is at least worthwhile in such cases for a copy of the software with its current software state to be created and for this copy to be transferred to the second terminal and not for example for the entire software to be transferred at once from one terminal to another.

Only when the software is running correctly on the second terminal will the execution of the software on the first terminal be ended.

So that the last, current software state is not lost, on switching off of all terminals or a deactivation of the software on all terminals which are assigned to one user for example, the last current state is transferred via the communication network to a software server connected to the communication network and stored by this.

With a more recent activation of one of the terminals and if necessary a corresponding request the software stored on a software server is then transmitted to the terminal—or, with agent software, the software is created and transmitted to the terminal—the stored software status is additionally transmitted and the software is supplied with this so that it can continue to run in the latest state.

So that a smooth execution of software on various, generally different terminals is guaranteed, it is necessary for the same runtime environment for the software to be used on the terminals and the software server.

For a concrete embodiment of the invention JAVA is used as runtime environment.

The software which is used in conjunction with invention can basically be any software, such as word processing software etc. The invention can for example be used to particularly good effect if the software is software for implementing voice connections and/or data connections, since in this case a connection can be transferred without interrupting the connection between two terminals.

The invention is explained below in more detail on the basis of a drawing. This shows

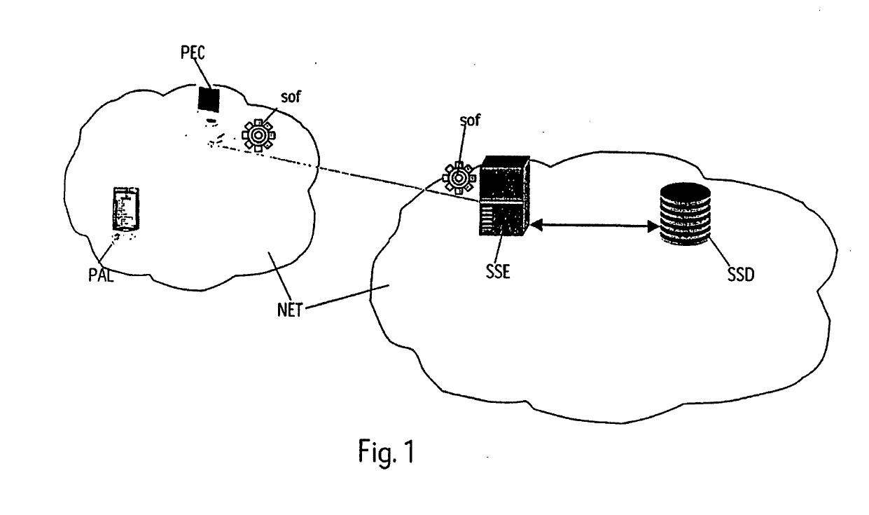

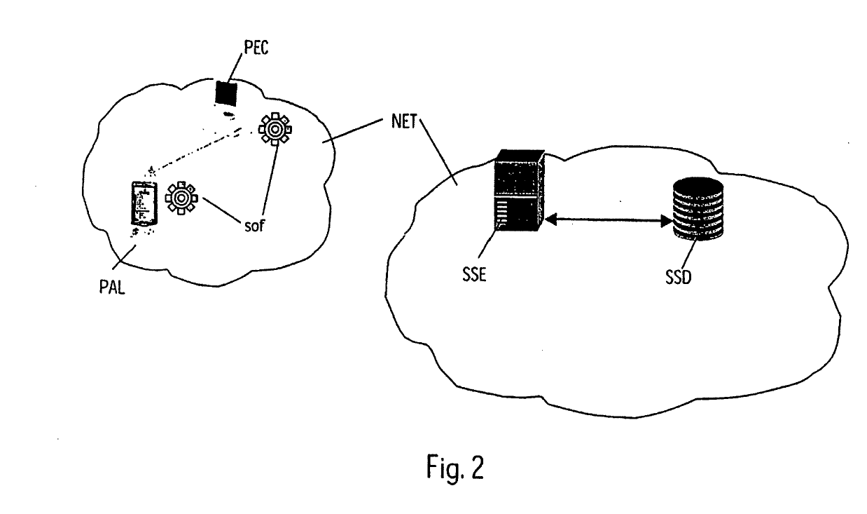

FIG. 1 and FIG. 2 a basic system to execute the method in accordance with the invention,

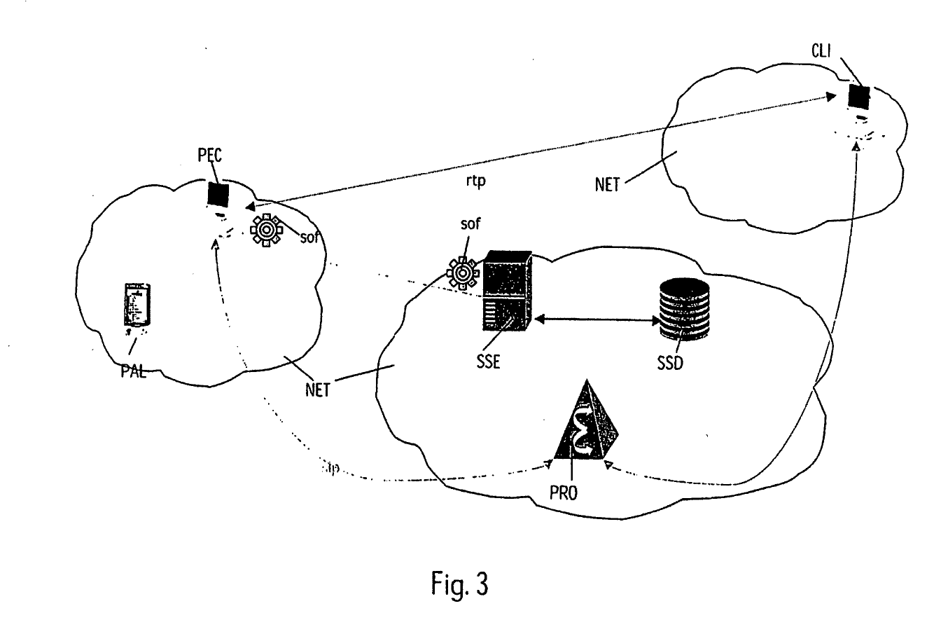

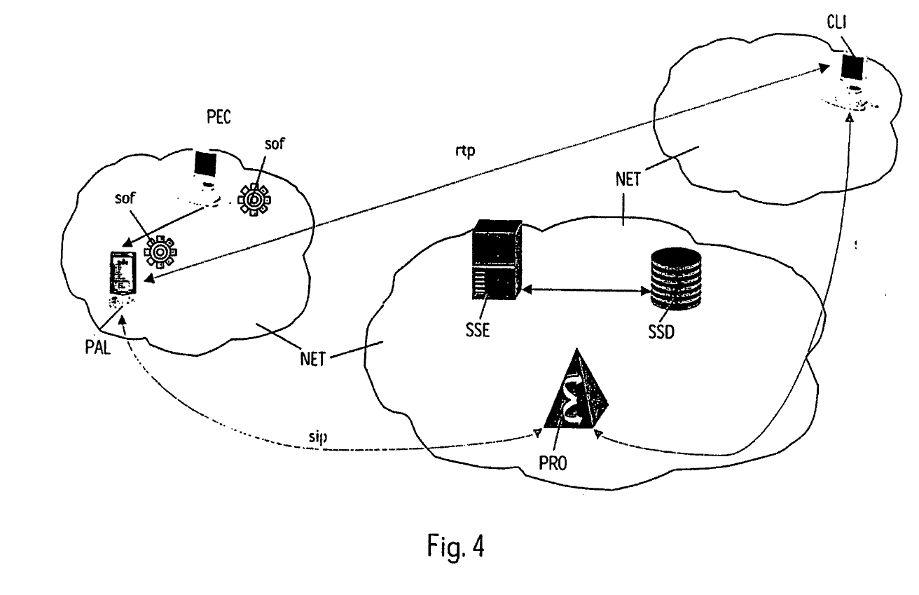

FIG. 3 and FIG. 4—a system to execute a method in accordance with the invention in conjunction with a voice-over-IP connection from terminals of the user to a distant terminal, and

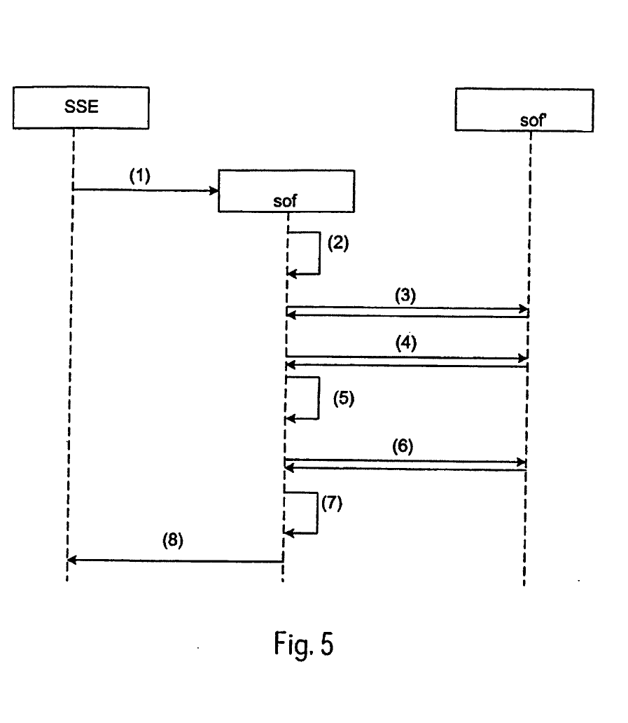

FIG. 5 the life cycle of a software agent used within the framework of the invention.

FIGS. 1 and 2 show a first simple example for keeping software sof or software states up to date on a number of terminals PEC, PAL. For example a user has a desktop computer PEC and also a handheld device PAL as well. In accordance with the basic idea of the invention, separate software for a specific application now no longer runs as was previously usual on each of these devices PAL, PEC, such as software for Contact Management which, when a new entry was made or an entry changed on one of the devices PEC, PAL would have to be synchronized on the other device, but the user only “has available” one executable software application for the specific application case concerned which is transferred backwards and forwards between the individual devices PEC, PAL on request.

The concrete software sof is stored when the terminals PEC, PAL are switched off on a software server SSE in a memory device SSD assigned to this. If the user now puts their desktop computer PEC into operation for example, either by a corresponding entry made by the user or automatically a request is transferred to the software server SSE and the desired software sof, such as contact management software, is transferred in the last current state to the desktop computer PEC. For communication between the individual terminals PEC, PAL and server SSE these are connected to each other via a communication network NET. In this case the term communication network is naturally also taken to mean the case in which the server is for example connected to a fixed network whereas one or more of the terminals may be connected to a mobile network and the connection is then established via this network.

If the user now wants to use the software sof on another terminal, for example there handheld PAL, a corresponding request is simply transferred to the desktop computer PEC and the software sof is transferred over the communication network NET to the handheld PAL.

With an advantageous embodiment of the invention, as explained in more detail below, what is known as agent technology is used. The software running on a terminal is then “agent programs”. In the text below the terminology whereby the relevant software is agent software is mostly used. In practice however this agent software as a rule consists of a number of “agents”, a master agent and one or more slave agents. These can communicate with the master agent and are intended to handle specific tasks while the master agent handles such tasks as communication “with the outside world” so that viewed from outside this software appears as a “single” software.

Basically an agent can move itself or be moved by another agent or an agent platform. The request for transmission of the software and the software state to another terminal is normally made here by an entry in the software—or in at the agent image in the master agent—, and is made on the device on which the software is currently running.

However there can also be provision for the request from outside to be made by an entry on another terminal, into another agent for example which then fetches the corresponding desired agent from the desired terminal to the requesting terminal.

After the requested software (the master agent) has received the requests it initiates the necessary steps for its migration to the other terminal. The communication itself is preferably undertaken via the NET, the TCP/IP protocol (“Transmission Control Protocol/Internet Protocol”) is used as the transmission protocol for the software sof.

In this case after the request arrives the software sof on the desktop computer is stopped in its current state with all its parameters, settings (“frozen”) and in transmitted in this state to the second terminal PAL where it then runs in the last current state.

As already mentioned above, the software used in an advantageous embodiment of the invention which is exchanged between the individual terminals or servers is based on what is known as agent technology which proves to be particularly useful for the invention because of the characteristics of agents explained below. A software agent is taken to be a program that accepts a task and performs it independently or autonomously undertakes user-defined tasks. Mobile software agents are programs in the form of autonomous objects which move around in a network of heterogeneous computers—typically Intranets or parts of the Internet—and in doing so provide services on behalf of a user or perform tasks. A software agent decides in such cases, based on local circumstances, whether, when and to where it wishes to migrate when necessary. With weak migration the dynamic process data of the software agent at specific program points is frozen by the agent system at the request of the software agent and packed together with context information and a variable data part into a message to be sent. At the destination location the process state is thawed out again and the agent continues seamlessly at the interrupted point. With strong migration the dynamic process state of the software agent is frozen by the agent system at a given point in the program and packed together with context information and a variable data part into a message to be sent. At the destination location the process state is thawed out again and the agent continues seamlessly at the interrupted point.

To perform its work the software agent interacts with the relevant local environment—the agent system, which is currently accommodating it, in which case it can also co-operate with other locally available or remote software agents. Furthermore a software agent can communicate with its client residing at another location, to provide intermediate results for example or to request new data and instructions. This last case however represents a rare event since by their very concept software agents are in a position to act largely independently.

The technology underlying software agents is described in U.S. Pat. No. 5,603,031 or EP 0 634 719. In conjunction with software agents the following further documents are publicly available:

“Walter Brenner, Rudiger Zarnekow, Hartmut Wittig: Intelligent software agents. Basics and application, Springer Verlag Berlin, 1998”; “Stan Franklin, Art Gaesser: Is it an Agent, or just a Program? A Taxonomy for Autonomous Agents.

Proceedings of the Third International Workshop on Agent Theories, Architectures, and Languages, Institute for Intelligent Systems, University of Memphis Springer-Verlag 1996”. When software agents are used it is thus also possible that it is not the software agent sof which is sent in its original form, but that it makes a copy of itself beforehand with the current software state and transfers this to the second terminal PAL. After this “clone” of the original agent sof has established that it is possible for it to function correctly in the new environment, it destroys the original on the desktop computer PEC.

The software state can only be forwarded directly on cloning and sending but not afterwards. After the cloning the original is thus blocked for all inputs so that the software state remains consistent.

The clone an hour represents an exact copy of the regional and this is the way of reliably ensuring that no information, settings etc. are lost during a transfer.

The prerequisite for the invention to function is merely that the terminals used have the same runtime environment for the agent software so that the latter can be executed on the various devices and the same agent platform. For example the well-known JAVA environment is used as the runtime environment.

Usually the agents themselves are JAVA programs and need JAVA everywhere as their runtime environment. For agents of different systems to communicate standardized interfaces of their platforms are necessary via which they can interact.

Java is an object-oriented programming language developed by Sun for Internet applications. Java is similar to the programming language C++, but dispenses with the latter's processor-specific adaptations. It is used for creation of platform-independent Applets which merely require an interpreter as well as specific browsers, for example Netscape Navigator, Oracle PowerBrowser, Mosaic from Spyglass and Sun Hot Java. Java supports functions such as text, hypertext, graphics, audio and animation.

Agents are complete applications and only need the interpreter but not a browser.

Naturally however other suitable runtime environments can also be used and the invention is not restricted to JAVA. A major advantage arising from what has already been stated is that completely platform-independent software can be transferred between individual terminals and also operated. Different operating systems on the individual terminals thus represent no obstacle to the functioning of the invention.

In accordance with the invention there is provision for the entire software in its latest state to be transmitted from a device PEC to another device PAL of the user. As a rule in this case the software will finish its service on the original device at the latest when the software on the “new” device begins to run.

The software can also basically run in parallel on a number of the user's devices, but only in the same software state. Also the software state cannot be exchanged between running programs. However it makes sense for the software to only ever be running on one device per user.

After the ending of the software on all the user's terminals PEC, PAL or after ending of the software on all terminals the software state of the software sof is again transmitted over the Internet NET to the software server SSE and stored in its latest state in the server's memory device SSD. The software itself is not stored on the agent server SSE since the class definitions of the relevant agents are stored on this in any event and the agent itself can be easily created again for a corresponding request.

An important point in the use of software agents sof is that, as well as the terminals PEC, PAL the software server SSE naturally also offers a runtime environment for the software agents. When a desired item of software is used for the very first time a user can for example create a desired software agent via the internet NET at such a software agent server SSE using a corresponding Internet page—within the framework of the limits offered by the provider. The Contact Management System already mentioned here could be given as an example, which users create for themselves in accordance with specific criteria—for example which basic entries should be present such as name, address telephone number etc. Entry of data is also already possible here as a rule. The “finished” software agent will then be transferred over the internet to the user's relevant terminal where, as already explained above, it will be transferred etc.

A further concrete exemplary embodiment of the invention is shown on the basis of FIGS. 3 and 4 in conjunction with internet telephony (VoIP, “Voice over Internet Protocol”).

A basic problem with telephony that also arises with VoIP is that during a telephone call the connection between various terminals of the user cannot be simply forwarded. If for example the user begins a VoIP call with their desktop PEC and would then like to continue this call with their handheld PAL, which could be connected to the Internet via a radio interface, they must usually clear the connection and re-establish it to do so. If the same standard is implemented on the two terminals PEC, PAL call forwarding is basically also possible. However, especially with such different devices as desktop and handheld computers, which as a rule normally feature different applications and operating systems, this is only seldom the case. This problem can be resolved with the invention in a way which is both simple and convenient for the user and this will be illustrated in more detail below on the basis of FIGS. 3 and 4 as well as additionally with FIG. 5 which shows the life cycle of a software agent. Here the reference symbols in brackets ( ) (numbers) refer to FIG. 5 in each case.

The agent sof is created in response to a request from a user—for example via their desktop computer PEC (1); At this point the agent is also given all user information such as settings, information about previous calls, and movement history which contains the addresses of all computers on which the agent has already run so that in future it can be conveniently selected from a list by an agent server SSE. Subsequently the agent sof is transmitted to the user's desktop PEC (2), where it then runs. From this point on the agent sof, which in this case is a communication program, is capable of establishing a connection to another terminal or accepting it if this is what the user requires.

As can now be seen in FIG. 3, in the case of a call the call parameters are negotiated via a signaling protocol sip with the distant station CLI by means of the agent sof in a first step (3). In this case the agent sof communicates with another agent soft or a communication application on the client computer CLI.

For example, as can be seen from FIG. 3, communication takes place via a proxy server PRO, using the “Session Initiation protocol” (SIP) sip. The “Session Initiation Protocol” (SIP) is a standard proposed by the Internet Engineering Task Force (IETF) for the transmission of real-time data over packet-based networks. The SIP protocol is functionally comparable with the H.323 protocol and can establish, modify and terminate interactive communication services. The SIP information can be transported over TCP or UDP (“User Datagram Protocol”). SIP possesses an open internet-based structure and allows CLASS (“Custom Local Area Signaling Service”) features such as the transmission of the identity of the caller or call forwarding in IP-based networks. SIP is responsible for call signaling, localization of users and registration. The class-of-service, directory accesses and the session procedures are taken over by other protocols.

After the signaling the transmission of the audio signals (4) begins. At this point it should be pointed out that the problems listed above do not just occur with telephones but generally with so-called multimedia connections. This is typically taken to mean the transmission of video or television pictures, sound transmissions, video telephony etc. in which a real-time data stream is transmitted over the Internet NET to a user's terminal and is output there. In this case also it is not possible or only possible in special vases to change the terminal without interrupting the connection via which the data stream is transferred and then re-establishing it from a new terminal. Thus if the typical connection between the desktop PEC and the client computer CLI involves video telephony, video data is also transmitted in addition to the audio data of the telephone conversation (4). The connection in this case will be handled by means of a corresponding connection protocol rtp, for example RTP (“Real Time Protocol”).

The RTP protocol was developed by the Audio-Video Transport Group of the IETF and is a component of H.323. It lies in the application layer and can handle network-based video or audio communication. To distinguish between the media RTP distinguishes between different encoding formats so that the data transmitted can be used independently of applications.

The Real Time Protocol (RTP) is based on an end-to-end connection and supports multicast but also unicast connections. It detects and corrects missing, duplicated or data packets received in incorrect order by using a 16-bit sequence number. For synchronization of audio or video the protocol uses a time stamp which is specified by the relevant RTP profile. In order to be able to uniquely identify the data source, the RTP Header has a 32-bit “synchronization Source Identifier” (SSRC) data field. In the second optional 32-bit data field, the “Content Source Identifier” (CSRC), the source addresses of the SSCRs are entered. The status information of the sources is a acknowledged by the RTCP protocol, which is a component of RTP, by periodic transmissions.

If a user now changes their terminal PEC, the communication agent sof, after a corresponding request, follows them to the new terminal PAL. So that communication is not interrupted during this migration of the agent sof, until the initialization routines have executed a specific sequence of events must occur. First the agent sof copies itself onto the new terminal PAL and takes all the necessary steps (searching for audio and video devices such as sound card, camera etc., testing the devices found, preparing and seizing the communication ports such as SIP or RTP ports) so that the signaling can be switched over The original agent here remains on the first terminal PEC until this has been successfully completed and maintains the connection with the client CLI for this time. After the new agent sof, i.e. the clone of the original agent, has ended its initialization it transfers the ongoing call to the new terminal PAL (5). Then the old agent finishes its service and the new agent sof, which represents an identical copy of the old agent, continues the services and the call. This is a way of reliably preventing the connection from being interrupted. To put it precisely the new agent itself transfers the ongoing call to itself by means of an SIP message (REINVITE) to the call partner. It then it terminates the “old” agents which then only make sure that the “old” slaves are also terminated.

After transfer is completed the desktop computer PEC is no longer included in the communication; This now runs directly from the handheld computer PAL to the client CLI, as if the communication had been directly taken up by the two terminals PAL, CLI.

As can be seen in FIG. 4 in this case the signaling of the “new” agent with the corresponding software of the client CLI is again undertaken for example using the SIP protocol, the subsequent transmission of data within the context of communications then takes place using the RTP protocol as explained above.

If after the end of the call (6) a user closes the application or switches the terminal PAL off without transmitting the agent sof to another terminal again, the software state is sent back to the agent server SSE, (7) the agent is destroyed and the last currant agent state is stored on the agent server (8). By using a uniform runtime environment such as JAVA complete independence from the terminal is achieved. The only requirement is that the corresponding runtime environment for the software agent can be executed on the terminal. The relevant agents can then be transferred without any problem between the widest range of terminals and especially also run on them. The same software can thus run on the widest variety of devices such as personal computer (PC), PocketPC, Handheld PC, mobile radio devices, etc. As a rule the Internet Protocol is used as the network layer protocol, the connection to the IP network can be stationary or mobile (wireless). As well as the functionality explained in detail above of “transferring” multimedia connections between two terminals, it is further easily possible with the invention to administer telephone books, address lists and other recordings or settings on any given personal device, with these changes then being valid for all personal devices.

1. Method for updating software (sof) on different terminals (PEC, PAL) which are connected to a communication network (NET), with the software implementing a voice connection and/or data connection,
characterized in that
a) at the request of the user of a terminal at least the software state of the software (sof) running on at least one of the terminals (PEC) is transmitted over the communication network (NET) to the second terminal (PAL), and
b) software running on the second terminal (PAL) corresponding to the software (sof) on the first terminal (PEC) is provided which the current transmitted software state and continues to run on the second terminal (PAL) in the last state that was current on the first terminal (PEC).

2. Method in accordance with claim 1,
characterized in that the software on the second terminal (PAL) corresponding to the software (sof) on the first terminal (PEC) is transmitted from a memory location (PAL, SSE, SSD) onto the second terminal (PAL).

3. Method in accordance with claim 2,
characterized in that a software server (SSE) is used as the memory location of the software.

4. Method in accordance with claim 2,
characterized in that the terminal (PEC) on which the software (sof) originally ran is used as the storage location of the software (sof).

5. Method in accordance with claim 1, characterized in that, in step a) the software state is packed into a message which is transferred to the second terminal (PAL).

6. Method in accordance with claim 1, characterized in that an agent software is used as the software.

7. Method in accordance with claim 5,
characterized in that the message further contains the storage location of the software (sof) or in the case of software agents (sof) at least the name of the main class and the storage location of the class definitions of the agent.

8. Method in accordance with claim 1, characterized in that the request by the second terminal (PAL) is made via the communication network (NET) to the first terminal (PEC).

9. Method in accordance with claim 1, characterized in that the request is issued by means of the first terminal (PEC) on which the software (sof) is running.

10. Method in accordance with claim 1, characterized in that for the request a unique address of the terminal (PAL) to which the software (sof) and the software state is to be transferred, is transmitted to the software (sof).

11. Method in accordance with claim 10,
characterized in that an IP address of the terminal (PAL) is used as the address.

12. Method in accordance with claim 1, characterized in that, after arrival of the
request the software (sof) is stopped in its execution on the first terminal (PEC) and this or the software state is transferred to the second terminal (PAL).

13. Method in accordance with claim 12,
characterized in that a copy of the software with its current software state is created and this copy is transferred to the second terminal (PAL).

14. Method in accordance with claim 13,
characterized in that when the software is running correctly on the second terminal (PAL) the execution of the software (sof) is ended on the first device (PEC).

15. Method in accordance with claim 1, characterized in that, when all terminals are switched off (PEC, PAL) or when the software (sof) is deactivated on all terminals (PEC, PAL) this or the last current state is transferred over the communication network (NET) to a software server (SSE) connected to the communication network (NET) and is stored by this server.

16. Method in accordance with claim 1, characterized in that the same runtime environment for the software (sof) is used on the terminals (PEC, PAL) and the software server (SSE).

17. Method in accordance with claim 16,
characterized in that JAVA is used as the runtime environment.
